(19) United States
(12) Patent Application Publication
(10) Pub. No.: US 2009/0003967 A1
(43) Pub. Date: Jan. 1, 2009

(54) LOBULAR DRIVE SYSTEM WITH INTERFERENCE FIT AND METHOD AND APPARATUS FOR FABRICATING SAME

(75) Inventor: Dennis Luna, Winnebago, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ACUMENT INTELLECTUAL PROPERTIES, LLC, Troy, MI (US)

(21) Appl. No.: 12/144,813

(22) Filed: Jun. 24, 2008

Related U.S. Application Data
(60) Provisional application No. 60/947,041, filed on Jun. 29, 2007.

(51) Int. Cl. F16B 23/00; B23G 9/00

(52) U.S. Cl. 411/404; 470/63; 470/205

(57) ABSTRACT

A fastener which includes a recess that includes a plurality of alternating lobes and recesses, where each of the flutes and lobes is twisted or angled. The fastener can be driven using a conventional multi-lobular driver. Alternatively, a driver which also has angled or twisted flutes and lobes can be used to engage the recess and drive the fastener. A punch pin includes a head that has a plurality of alternating lobes and recesses that are twisted or angled. The head of the punch pin is configured to punch the recess into the head of the fastener. A device retains the punch pin such that the punch pin can rotate out of the recess after the punch pin punches the recess into the head of the fastener.

### RELATED APPLICATION (PRIORITY CLAIM)

This application claims the benefit of U.S. Provisional Application Ser. No. 60/947,041, filed Jun. 29, 2007, which is hereby incorporated herein by reference in its entirety.

### BACKGROUND OF THE INVENTION

The present invention generally relates to lobular drive systems, and more specifically relates to a lobular drive system and method and apparatus for fabricating same.

Fasteners are a critical component of many structures and mechanisms, from the simplest machine to a highly complex space shuttle. Because of the critical functions performed by these fasteners, improvements in their structure and functional properties are continually sought. One such improvement is the TORX® brand drive system, which can be employed, for example, in a drive socket or on a head portion of a fastener, or on a drive bit or socket used for driving such a fastener into a workpiece.

The construction and benefits of the TORX® brand drive system are disclosed in U.S. Pat. No. 3,584,667, which is hereby incorporated herein by reference in its entirety. The TORX® brand drive system represents a significant improvement in the fastener industry.

An application of the TORX® brand drive system is disclosed in U.S. Pat. No. 4,269,246, which is hereby incorporated herein by reference in its entirety. Specifically, the drive bit of the '246 patent provides means for providing a wedging effect between the bit and a fastener for holding fasteners on the drive bit when the bit is inserted in a recess or socket on the fastener, thereby facilitating one-handed installation of fasteners into a workpiece. This one-handed installation is highly desirable for use in some applications of fasteners where a large number of fasteners are to be installed in a workpiece, or a plurality of workpieces, such as on an assembly line. This type of friction engagement is also desirable where it is preferred to use non-magnetic drives and fasteners. Additionally, the particular construction of the '246 patent helps to prevent “walking” or “wobble” of a fastener, which can cause damage to workpiece. This “walking” or “wobble” is particularly acute when a pilot hole is not used or during manual installation of self-tapping or self-drilling screws. The drive bit is also self-aligning, which provides significant benefits when utilizing drill screws.

Even though the fastener and the drive bit or assembly provided by the '246 patent are quite effective, there is always room for further improvements or refinements. Specifically, the drive bit of the '246 patent has a tree degree taper on a major diameter thereof. As such, the drive bit makes contact with the fastener at a top of the fastener socket into which the bit is inserted. More definitely, the contact between the bit and the fastener socket occurs at outer, leading edges of lobes on the bit and a center of flutes in the socket. The bit wedges across a major diameter of the bit Accordingly, the above-discussed wedging effect theoretically occurs at six contact “points,” equal in number to the number of flutes and lobes, between the bit and the socket. Because wedging between the bit and the socket occurs only at outside edges of the lobes of the drive bit, high magnitude mechanical stresses can build up at these limited locations. This stress concentration can cause excessive bit wear, as well as loss of dimensional tolerances.

Furthermore, because of the limited contact between the bit and the fastener, a natural tendency arises causing the bit to cam out of the socket in the fastener. Accordingly, there is a potential that the effective lifetime of the drive bit will suffer a reduction, viz. a reduction in ability to prevent wobble, as well as a reduction in the integrity of an interference fit between the bit and the fastener which can make one-handed manual installation more difficult. Additionally, variations in socket fall away, as measured across the major diameter of the socket, which may be difficult to eliminate, can adversely affect depth of penetration of the drive bit into the socket, thereby adding variability of insuring sufficient bit penetration into the socket for driving of the fastener.

Despite there being lobular drive systems available, there is a need for a lobular drive system which provides an improved interference fit. The interference fit tends to become enhanced when the fastener is being tightened, and tends to become diminished when the fastener is attempted to be loosened, thereby providing a certain level of tamper resistance once the fastener has been installed.

### OBJECT AND SUMMARY

An object of an embodiment of the present invention is to provide an improved lobular drive system.

Another object of an embodiment of the present invention is to provide a lobular drive system which provides an enhanced interference fit.

Still another object of an embodiment of the present invention is to provide a lobular drive system which provides at least two contact points per lobe—one on a leading edge of the lobe, and one on a trailing edge.

Yet another object of an embodiment of the present invention is to provide a lobular drive system which provides some measure of tamper resistance.

Several embodiments of the present inventions are possible, some of which are illustrated herein. One embodiment of the present invention provides a drive system which can be embodied on the head of a driver (or driver bit), in a drive socket, on a fastener head post or in a fastener socket.

For example, a specific embodiment of the present invention which is illustrated herein is in the form of a fastener which includes a socket or recess that includes a plurality of alternating lobes and recesses, where each of the lobes and recesses are twisted or angled. The fact that each of the lobes and recesses are twisted or angled provides an enhanced interference fit in the form of at least two contact points per lobe—one on a leading edge of the lobe, and one on a trailing edge—as well as a measure of tamper resistance.

It should be noted that engagement at two contact points for each of the six lobes, or however many are employed in the multi-lobular design, is the theoretical maximum. Due to tolerances and wear during use, engagement may occur at fewer contact points per lobe or at fewer than all of the lobes.

The fastener is configured such that the fastener can be driven using a conventional multi-lobular driver (such as one which is consistent with that which is disclosed in U.S. Pat. No. 3,584,667). Alternatively, the fastener can be driven by a driver which is in accordance with another embodiment of the present invention, where the driver has a drive head which also has a plurality of corresponding alternating lobes and recesses which are twisted or angled.

Still another embodiment of the present invention which is illustrated herein is a punch pin which includes a head that has a plurality of alternating lobes and recesses which are angled or twisted. The head of the punch pin is configured to punch into the head of a fastener thereby forming the recess discussed above.

Still yet another embodiment of the present invention which is illustrated herein is a device which is configured to retain and use the punch pin to punch the recess into the head of the fastener. The device may include, for example, a pin holder, bearing and packing that are all disposed in a casing. The device is configured to retain the punch pin in a manner such that the punch pin is free to spin while being retained. As such, the device can be used to punch the head of the punch pin into the head of the fastener, and as the head of the punch pin is withdrawn from the recess which has been formed in the fastener, the head of the punch pin can effectively rotate out of the recess.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an enlarged perspective view of a fastener which is in accordance with an embodiment of the present invention;

FIG. 2 is an enlarged side view of the fastener shown in FIG. 1;

FIG. 3 is an enlarged top view of the fastener shown in FIG. 1;

FIG. 4 is a cross-sectional view of the fastener shown in FIGS. 1-3, taken along line 4-4 of FIG. 3;

FIG. 5 is a perspective view of a multi-lobular driver bit that can be used to drive the fastener shown in FIGS. 1-4;

FIG. 6 illustrates a head of the driver bit shown in FIG. 5, inserted in a recess which is provided in the head of the fastener shown in FIGS. 1-4;

FIG. 7 is similar to FIG. 6 but shows certain lines of the recess in the head of the fastener in phantom, so that engagement with the head of the driver bit can be more readily seen;

FIG. 8 is a top view of the driver bit engaged with the fastener;

FIG. 9 is a cross-sectional view taken along line 9-9 of FIG. 8;

FIG. 10 is a cross-sectional view taken along line 10-10 of FIG. 7;

FIG. 11 is a perspective view of a punch pin, which is in accordance with an embodiment of the present invention, and which can be used to form the recess in the head of the fastener shown in FIGS. 1-4;

FIG. 12 is an enlarged perspective view of a head of the punch pin shown in FIG. 11;

FIG. 13 is an enlarged view of the end of the punch pin shown in FIG. 11;

FIG. 14 is a block diagram illustrating a method which is in accordance with an embodiment of the present invention, where the method can be used to form the punch pin shown in FIG. 11;

FIG. 15 is a cross-sectional view of a device which can be used to cause the punch pin to punch a recess in the head of a fastener; and

FIG. 16 is a block diagram illustrating a method which is in accordance with an embodiment of the present invention, where the method can be used to punch a recess in a fastener.

### DETAILED DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

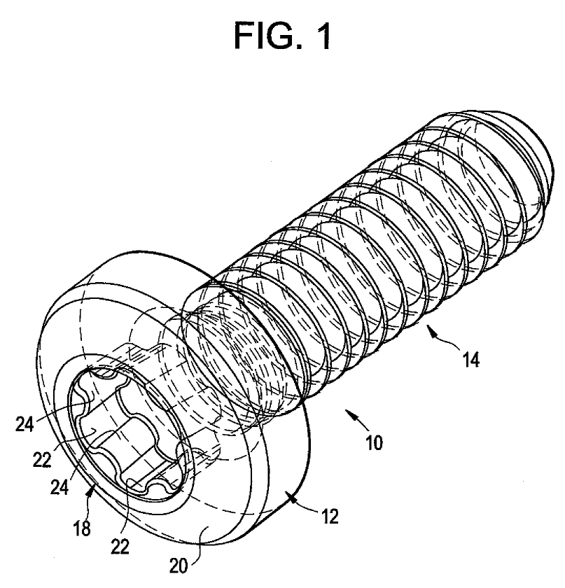

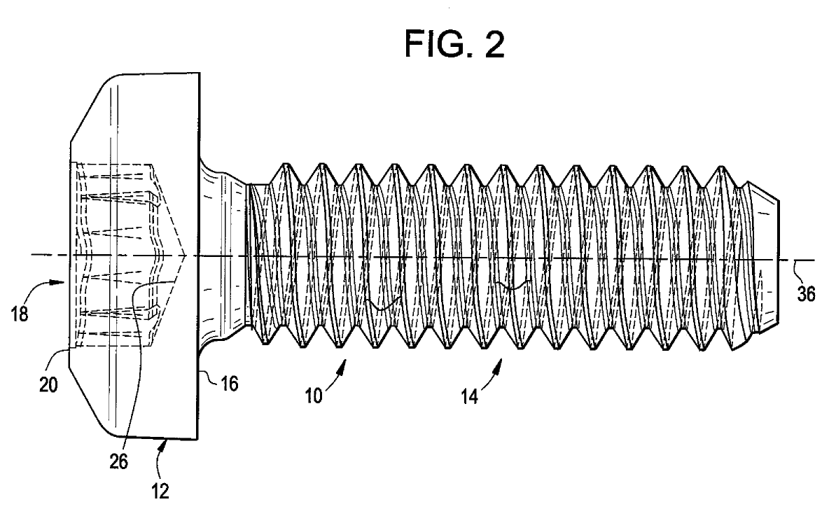

FIGS. 1-4 illustrate a fastener 10 which is in accordance with an embodiment of the present invention. The fastener 10 includes a head portion 12, and a threaded shaft portion 14 which extends from a bottom 16 of the head portion 12. A socket or recess 18 is provided in a top 20 of the head portion 12, and the recess 18 includes alternating flutes 22 and lobes 24, and a bottom 26 of the recess. 18 is generally conical. Although a different number of flutes and lobes can be provided, preferably there are six lobes 24 and six flutes 22, wherein each is spaced equidistantly along the circumference of the recess with adjacent lobes 24 being separated by a flute 22.

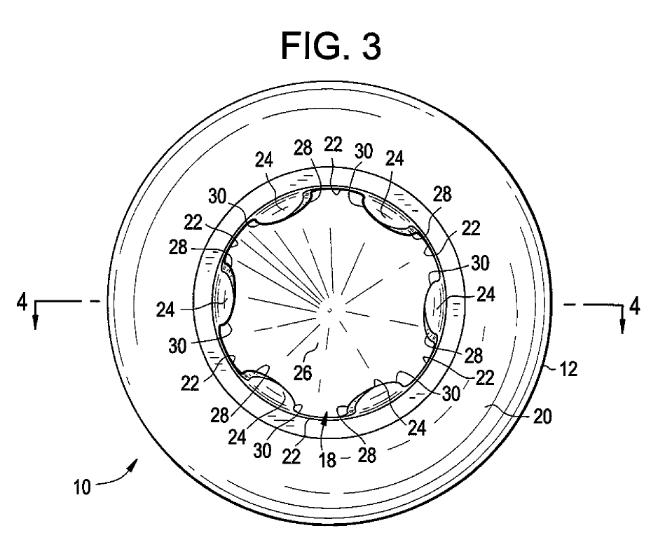

Regardless of the number of flutes and lobes which are provided, the flutes 22 and lobes 24 of the recess 18 in the head 12 of the fastener 10 shown in FIGS. 1-4 depart from the configuration disclosed in U.S. Pat. No. 3,584,667 in that instead of being straight, the flutes 22 and lobes 24 of the fastener 10 shown in FIGS. 1-4 are twisted or angled. Preferably, the flutes 22 and lobes 24 are angled in a clockwise direction as one moves in the recess 18 from the top 20 of the head 12 of the fastener 10 toward the bottom 26 of the recess 18. As such, in FIG. 3 leading edges or walls 28 of the lobes 24 are visible when looking down into the recess 18, while trailing edges or walls 30 are generally not visible.

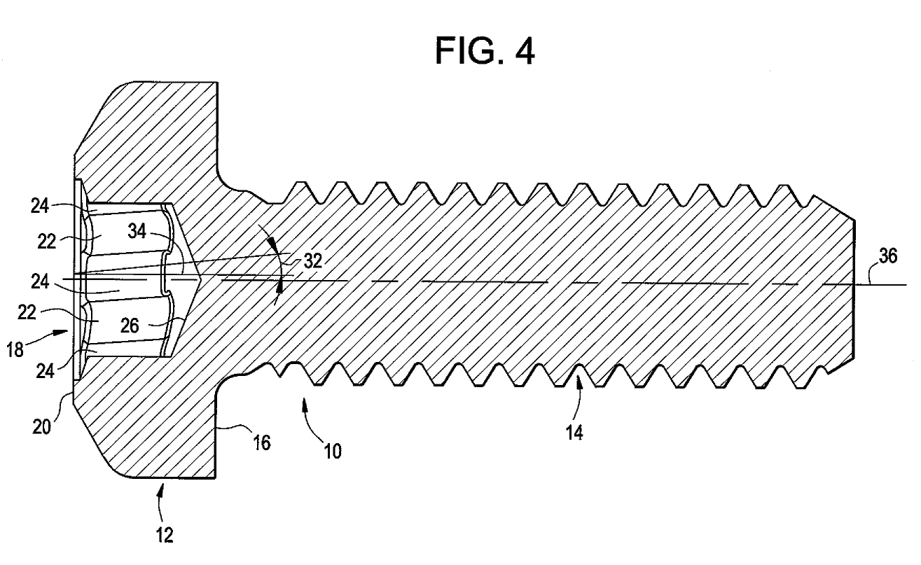

The angle of twist of the flutes 22 and lobes 24 is shown best in FIG. 4, which is a cross-sectional view taken along line 4-4 of FIG. 3. In FIG. 4, the angle of twist is identified with reference numeral 32. The angle is relative to a line 34 which is parallel to the longitudinal axis 36 of the fastener 10. Preferably, this angle is at least 3 degrees and at most 12 degrees, but some other angle can be selected. The greater the angle of twist, the greater the amount of tamper resistance, as a driver which is engaged in the recess 18 will have more of a tendency to ride out of the recess 18 while being driven in a counterclockwise direction to back the fastener 10 out of a threaded bore in a workpiece.

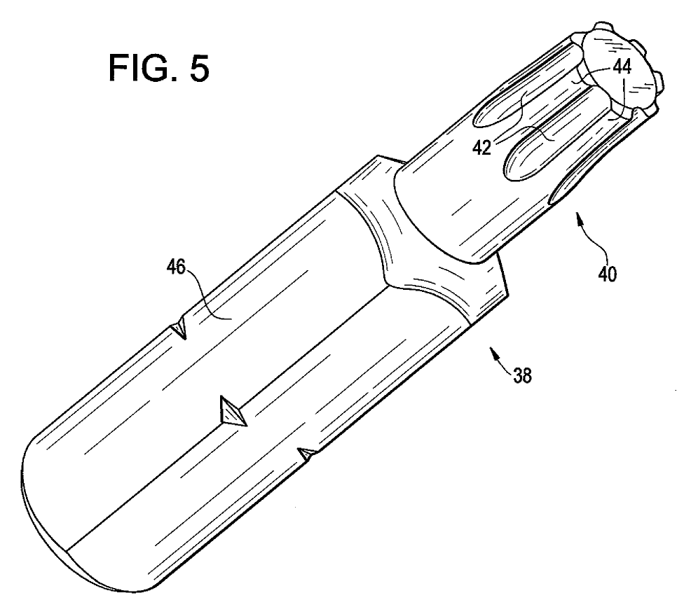

A conventional multi-lobular driver or driver bit 38 such as shown in FIG. 5 (see also U.S. Pat. No. 3,584,667) can be used to drive the fastener 10, wherein the driver or driver bit 38 has a fastener-engaging portion or drive head 40 that includes alternating flutes 42 and lobes 44. One having ordinary skill in the art would understand that the drive head 40 can be provided on a driver bit 38 (such as shown in FIG. 5) which includes a tool shank portion 46 that is constructed to be engaged with an appropriate tool, such as a wrench, drill or the like (not shown), for applying a torque to the bit 38 and therefore also to the fastener 10. Alternatively, the drive head 40 can be provided directly on a driver without having to use a bit. As such, the term “driver” is used herein to effectively cover both of these scenarios, despite the fact that a driver bit is specifically shown in the drawings as an example.

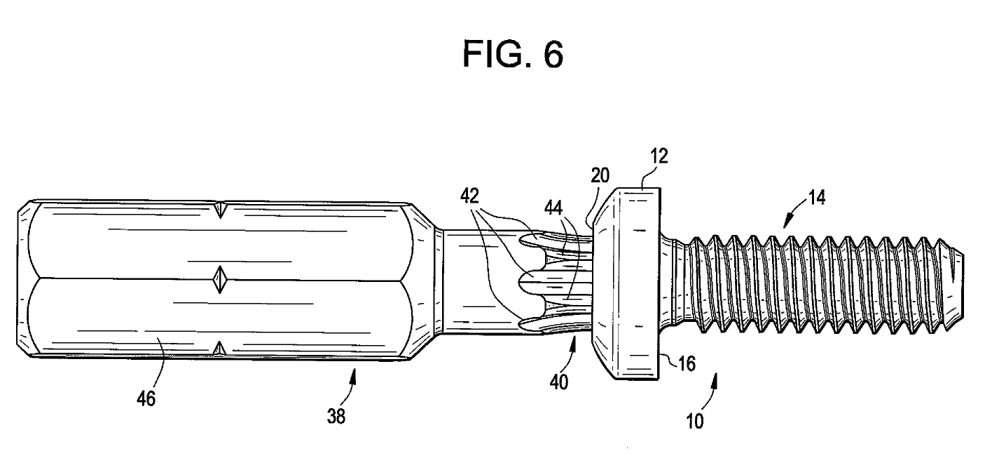

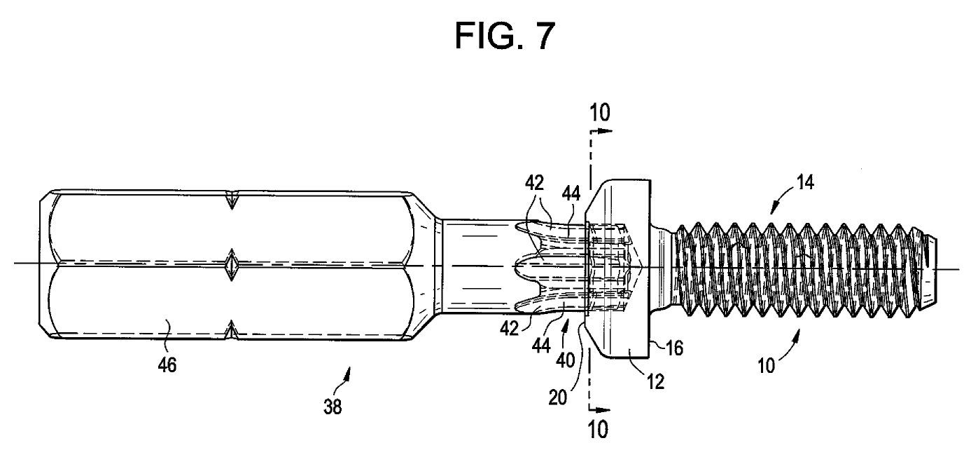

FIG. 6 shows the head 40 of such a driver 38 engaged with the head 12 of the fastener 10 shown in FIGS. 1-4. As shown in FIG. 7, the head 40 of the driver 38 engages the socket or recess 18 in the head 12 of the fastener 10. Specifically, lobes 44 of the head 40 of the driver 38 engage in flutes 22 of the recess 18, and lobes 24 of the socket or recess 18 of the fastener 10 engage in flutes 42 in the head 40 of the driver 38.

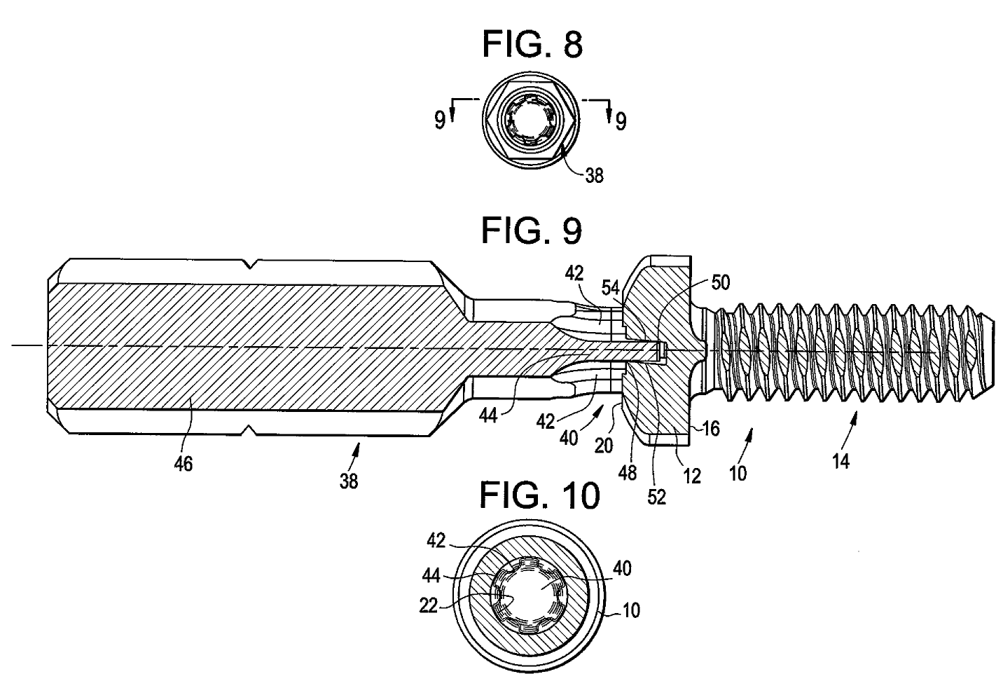

FIG. 10 is a cross-sectional view taken along line 10-10 of FIG. 7, and illustrates the engagement of the lobes 44 and flutes 42 of the driver 38 with the flutes 22 and lobes 24, respectively, of the recess 18 in the head 12 of the fastener 10. Since the head 40 of the driver 38 is conventional, the flutes 42 and lobes 44 thereof are not twisted or angled like the lobes 24 and flutes 22 of the recess 18 in the head 12 of the fastener 10. As such, as shown in FIG. 9 (which is a cross-sectional view taken along line 9-9 of FIG. 8), when the head 40 of the driver 38 is engaged in the recess 18, an interference fit or wedging action occurs between the lobes 44 of the head 40 of the driver 38 and the flutes 22 in the recess 18—i.e., at points 48 and 50 in FIG. 9. As such, theoretically there are two points of contact for each lobe 44 of the driver 38—one on the leading edge 52 of each lobe 44, and one on the trailing edge 54 of each lobe 44. It should be noted that engagement at two contact points for each of the six lobes 44 of the driver 38, or however many are employed in the multi-lobular design, is the theoretical maximum. Due to tolerances and wear during use, engagement may occur at fewer contact points or at fewer than all of the lobes. A similar interference fit or wedging action occurs between the lobes 24 in the recess 18 in the head 12 of the fastener 10 and the flutes 42 in the head 40 of the driver 38.

Preferably, the extent of the twist of the flutes 22 and lobes 24 in the recess 18 in the head 12 of the fastener 10 is not so extreme such that the depth of penetration or insertion of the drive head 40 is sufficient to reduce any tendency for the drive head 40 to cam out of the recess 18 when the fastener 10 is driven into a workpiece. Because of the cam out resistance provided by the configuration, an end load is not required to install a fastener 10 in a threaded bore in a workpiece. However, when self-tapping or drill screws are used, often no pilot hole is provided. Accordingly, when self-tapping screws are utilized, an end load is required for facilitating tapping or drilling of the screw into the workpiece. With the particular contact line-point of contact configuration provided by the drive head 40, the driver 38 is able to utilize this requisite end load to minimize wobble or walking of self-tapping screws as they are driven into a workpiece. Thus, the twist or angle of the flutes 22 and lobes 24 of the recess 18 of the fastener 10 are able to perform not only as means for preventing cam out and means for aligning the fastener 10 with the driver 38, but also as means for reducing wobble.

Due to the twist or angle of the flutes 22 and lobes 24 of the recess 18 in the head 12 of the fastener 10 being angled in a clockwise direction, the interference fit between the head 40 of the driver 38 and the recess 18 in the head 12 of the fastener 10 tends to become enhanced when the driver 38 is being rotated clockwise, i.e. when the driver 38 is used to tighten the fastener 10. In contrast, the interference fit between the head 40 of the driver 3 8 and the recess 18 in the head 12 of the fastener 10 tends to diminish while the driver 38 is being rotated counterclockwise, i.e. when the driver 38 is used to attempt to loosen the fastener 10. In other words, due to the direction of the angle of twist of the flutes 22 and lobes 24 in the recess 18 in the head 12 of the fastener 10, the driver 38 tends to ride out of the recess 18 when rotated counterclockwise. This provides some measure of tamper resistance. This tamper resistance feature can be enhanced by increasing the angle of the twist of the lobes 24 and flutes 22 of the recess 18.

Furthermore, a driver can be provided which also has angled or twisted flutes and lobes, wherein the driver is in accordance with an embodiment of the present invention. This would increase the tendency of the driver to ride out of engagement with the recess 18, thereby providing tamper resistance. The extent of twist of the flutes and lobes on the driver may be less than or substantially equal to the extent of the twist of the flutes 22 and lobes 24 of the recess 18 in the head 12 of the fastener 10. Regardless, the driver may be constructed from any suitable material having sufficient structural integrity for applying the necessary torque to the fastener.

Although the twisted flutes and lobes have been described in association with a recess in the head of a fastener as well as possibly a drive head on a driver or driver bit, such a drive system may instead be embodied in the form of alternating twisted flutes and lobes in a drive socket and/or on a fastener head post.

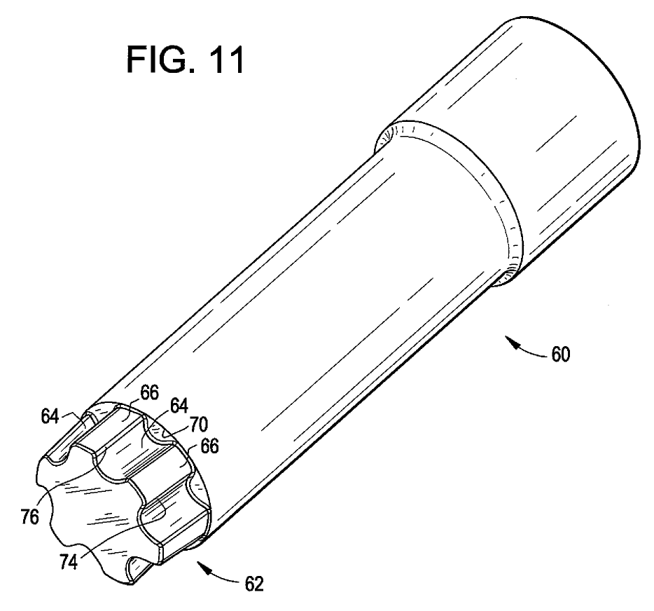

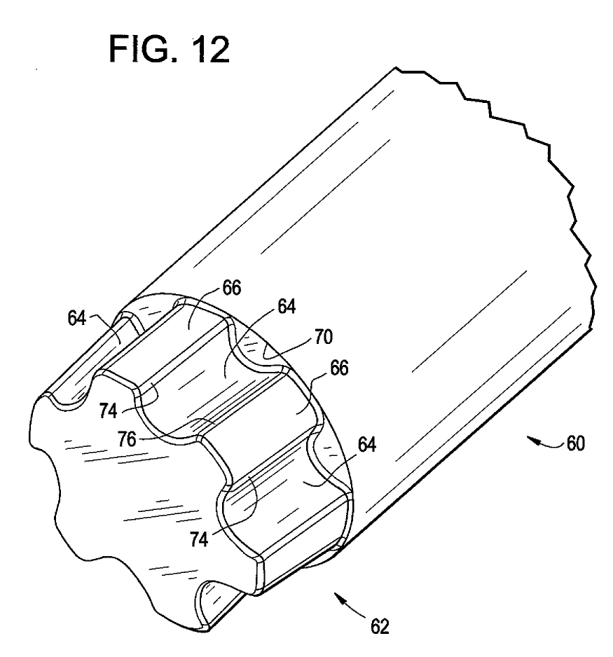

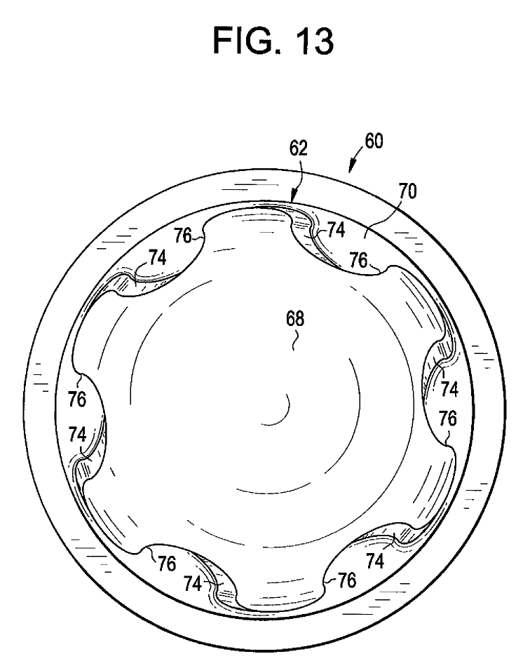

FIG. 11 illustrates a punch pin 60 which is in accordance with an embodiment of the present invention and which can be used to punch the recess 18 in the fastener 10 described hereinabove. The punch pin 60 has a punch head 62, which is shown in enlarged detail in FIG. 12, that has alternating flutes 64 and lobes 66 and the alternating flutes 64 and lobes 66 are twisted or angled. Preferably, the flutes 64 and lobes 66 are angled in a clockwise direction as one moves from a top surface 68 of the head 62 of the punch pin 60 to a shoulder 70 provided on the punch pin 60, at the bottom 72 of the flutes 64 and lobes 66. As such, in FIG. 13, walls 74 of the lobes 66 are visible when looking down the end 68 of the punch pin, while walls 76 of the lobes 66 are generally not visible. The degree of twist is such that it corresponds to the extent of twist ultimately desired in the recess 18 of the fastener 10 (such as a three to twelve degree twist, as described hereinabove). The punch pin 60 can be constructed from any suitable material having sufficient structural integrity and hardness to punch the recess 18 into the head 12 of the fastener 10.

While the punch pin 60 has been described in connection with punching a recess 18 in the head 12 of a fastener 10, the punch pin 60 can also be used to punch a recess in a drive socket, wherein the formed drive socket can thereafter be used to engage and drive a fastener head post, which may also have either straight (i.e., conventional) or twisted flutes and lobes, in accordance with an embodiment of the present invention.

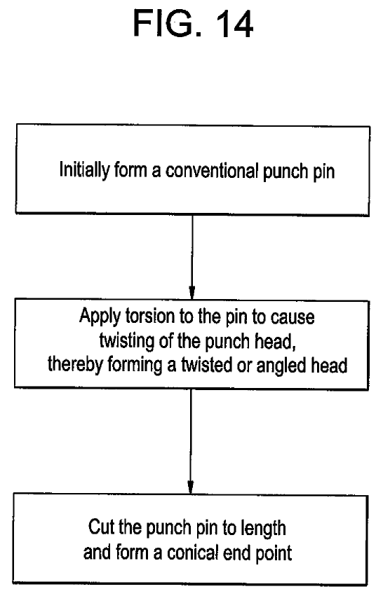

As shown in FIG. 14, to form the punch pin 60, a conventional punch pin can initially be formed, and then torsion can be applied to the punch pin to cause twisting of the punch head. Finally, the end of the punch pin can be cut to length and a conical end point can be formed on the end of the punch pin.

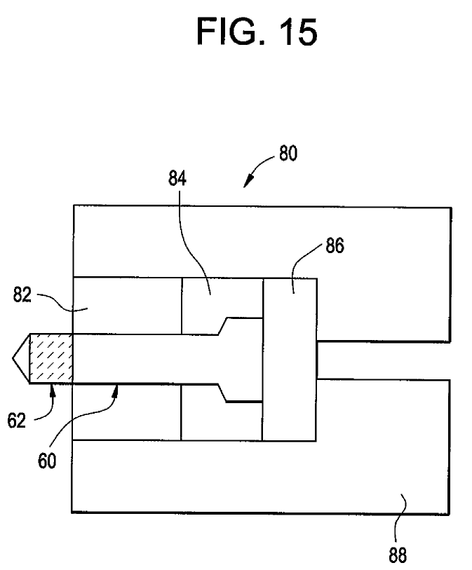

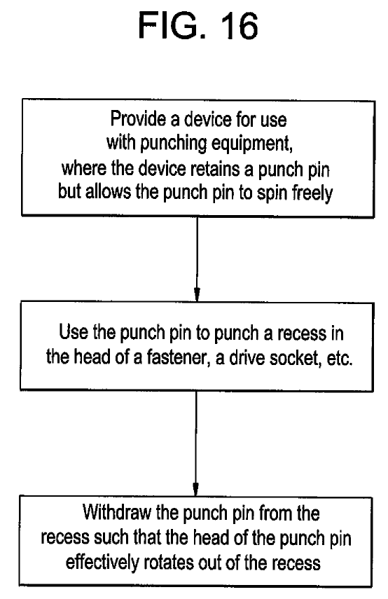

FIG. 15 illustrates a device 80 which is in accordance with an embodiment of the present invention. The device 80 can be used to retain the punch pin 60 shown in FIG. 11, and use the punch pin 60 to punch the recess 18 in the fastener 10 shown in FIG. 1. As shown in FIG. 15, the device 80 preferably includes a pin holder 82, bearing 84 and packing 86 that are all disposed in a casing 88 which can be used with conventional punching equipment. The device 80 is configured to retain the punch pin 60 in a manner such that the punch pin 60 is free to spin while being retained. In other words, the punch pin 60 can spin free relative to the pin holder 82 and bearing 84. As such, as shown in block diagram form in FIG. 16, the device 80 can be used with conventional punching equipment to punch the head 62 of the punch pin 60 into the head 12 of the fastener 10, and as the head 62 of the punch pin 60 is thereafter withdrawn from the recess 18 which has been formed in the fastener 10, the head 62 of the punch pin 60 can effectively rotate out of the recess 18, thereby leaving the twisted or angled flutes 22 and lobes 24 of the recess 18 intact.

While preferred embodiments of the invention are shown and described, it is envisioned that those skilled in the art may devise various modifications without departing from the spirit and scope of the foregoing description.

What is claimed is:

1. A fastener comprising: a head portion having a top and a bottom; and a threaded shaft portion which extends from the bottom of the head portion, wherein a socket is provided in the top of the head portion, wherein the socket comprises alternating flutes and lobes, the flutes and the lobes are twisted.

2. The fastener as recited in claim 1, wherein the socket comprises six lobes and six. flutes.

3. The fastener as recited in claim 1, wherein the lobes and the flutes are spaced equidistantly along a circumference of the socket.

4. The fastener as recited in claim 1, wherein the lobes and the flutes are angled in a clockwise direction as one moves in the socket from the top of the head portion of the fastener toward a bottom of the socket.

5. The fastener as recited in claim 4, wherein leading walls of the lobes are visible when looking down into the socket, while trailing walls are not visible.

6. The fastener as recited in claim 1, wherein the lobes and the flutes are twisted at an angle relative to a line which is parallel to a longitudinal axis of the fastener, wherein the angle is at least 3 degrees.

7. The fastener as recited in claim 1, wherein the lobes and the flutes are twisted at an angle relative to a line which is parallel to a longitudinal axis of the fastener, wherein the angle is at most 12 degrees.

8. The fastener as recited in claim 1, wherein the lobes and the flutes are twisted at an angle relative to a line which is parallel to a longitudinal axis of the fastener, wherein the angle is between 3 and 12 degrees.

9. The fastener as recited in claim 1, wherein the fastener is configured such that when the head of a driver is engaged in the socket, a wedging action occurs between lobes of the head of the driver and the flutes in the socket of the fastener.

10. The fastener as recited in claim 9, wherein the fastener is configured such that a similar wedging action occurs between the lobes in the socket in the head portion of the fastener and the flutes in the head of the driver.

11. A punch pin configured to punch a recess in a part, said punch pin comprising: a punch head comprises alternating flutes and lobes, wherein the flutes and the lobes are twisted.

12. The punch pin as recited in claim 11, wherein the punch head comprises six lobes and six flutes.

13. The punch pin as recited in claim 11, wherein the lobes and the flutes are spaced equidistantly along a circumference of the punch head.

14. The punch pin as recited in claim 11, wherein the lobes and the flutes are twisted at an angle relative to a line which is parallel to a longitudinal axis of the punch pin, wherein the angle is at least 3 degrees.

15. The punch pin as recited in claim 11, wherein the lobes and the flutes are twisted at an angle relative to a line which is parallel to a longitudinal axis of the punch pin, wherein the angle is at most 12 degrees.

16. The punch pin as recited in claim 11, wherein the lobes and the flutes are twisted at an angle relative to a line which is parallel to a longitudinal axis of the punch pin, wherein the angle is between 3 and 12 degrees.

17. The punch pin as recited in claim 11, wherein the lobes and the flutes are twisted in a clockwise direction, from a top surface of a head f the punch pin to a shoulder provided on the punch pin, at a bottom of the flutes and lobes.

18. A method of making a punch pin, said method comprising: forming a punch pin having a punch head with alternating flutes and lobes; and applying torsion to the punch pin to cause twisting of the punch head, whereby the punch pin comprises alternating lobes and flutes which are twisted.

19. A method of using a punch pin to punch a recess into a part, said method comprising: providing a device for use with punching equipment; engaging a punch pin with the device, wherein the punch pin comprises a punch head having alternating flutes and lobes which are twisted, wherein the device is configured to allow the punch pin to spin freely; using the punch pin to punch the recess into the part; and withdrawing the punch pin from the recess such that the punch head rotates out of the recess.

20. The method as recited in claim 19, wherein the step of providing a device comprises providing a casing, a pin holder in the casing, a bearing in the casing and packing in the casing.
